(19) United States
(12) Patent Application Publication
(10) Pub. No.: US 2007/0030206 A1
(43) Pub. Date: Feb. 8, 2007

(54) Method for operating a transmitting/receiving station of a wireless communication network in antenna diversity mode

(76) Inventors: Patrick Fontaine, Rennes (FR); Vincent Demoulin, Montfort sur Meu (FR); Ludovic Jeanne, Rennes (FR)

Correspondence Address: THOMSON LICENSING INC., PATENT OPERATIONS, PO BOX 5312, PRINCETON, NJ, 08543-5312, US

(21) Appl. No.: 10/576,823

(22) PCT Filed: Oct. 19, 2004
(86) PCT No.: PCT/EP04/11834

§ 371 Date: Apr. 24, 2006

(30) Foreign Application Priority Data
Oct. 24, 2003 (FR) 0312436

(51) Int. Cl. H01Q 21/00

(52) U.S. Cl. 343/725

(57) ABSTRACT

A method for operating a transmitting/receiving station of a wireless communication network in antenna diversity mode, this station having a plurality of reception antennas, consists in listening to the communications between two other transmitting/receiving stations of the network, successively on each reception antenna, then analysing the quality of listening on each reception antenna so as to identify a reception antenna from among the plurality of reception antennas which sets up the best communication link with one of the said other two transmitting/receiving stations.

### 1. FIELD OF THE INVENTION

The invention relates to a method for operating a transmitting/receiving station of a wireless communication network in antenna diversity mode.

The invention is intended more particularly for a wireless communication network using the IEEE802.11 American standard or the Hiperlan/2 European standard of the ETSI (“European Telecommunications Standards Institute”), in which there are direct links between stations of the network.

### 2. STATE OF THE ART

In particular, in the case of the IEEE802.11 standard, the wireless communication network can be an “ad hoc” network in which there is no access point and in which each station can communicate with all the other stations of the network. The communication network can also be centralized (i.e. BSS stands for “Basic Service Set”). In this case, stations communicate only with one station of the “AP” type (“Access Point”).

For the Hiperlan/2 standard the stations may be of two types: station of the “CC” type (“central controller”) and station of the MT type (“mobile terminal”).

Moreover, the communication links may be of three types: links of the “downlink” type (downlink from a CC station to an MT station); link of the “uplink” type (uplink from an MT station to a CC station); link of the “direct link” type (direct link between two MT stations).

In such a wireless communication network, the communication link between two stations of the network can be cut by an obstacle, such as the transit of a person, this possibly affecting the performance of the network. To make the network less sensitive to noise and to interference, each station of the network operates in antenna diversity mode and regularly undertakes the identification of the reception antenna from among its plurality of reception antennas which sets up the best communication link with the other transmitting/receiving stations of the network.

In the IEEE802.11 standard, the communications between the fixed or mobile stations of the network, more particularly computers and access points (or nodes of the network), are done by transfer of
control frames, of small sizes, such as the so-called “RTS” and “CTS” frames, standing respectively for “Request To Send” and “Clear To Send”, used to control access to the medium, and “ACK” standing for “Acknowledgement” for validating the reception of data,
data frames, so-called “DATA” frames, used for the transmission of the data and possibly containing a great deal of information,
management frames used for exchanging network management information.

The mechanism of communication between the stations of the network (that is to say the mechanism for accessing the communication medium), called “DCF” (“Distributed Coordination Function”) utilizes the “CSMA/CA” communication protocol (“Carrier Sense Multiple Access with Collision Avoidance”) and is described hereinbelow:
A first station wishing to dispatch data to a second station sends an RTS frame to all the stations in its transmission radiation to reserve the communication medium for a certain duration. The RTS frame contains the identifier of the “MAC ID” transmitting station (“Medium Access Control IDentification”), and the identifier of the station receiving these data as well as the duration of the communication between the two stations.
The second station responds, if the medium is free, to all the stations in its transmission radiation to signal its acceptance of the transfer of data with a CTS frame, containing the same information as the RTS frame.
All the stations, other than the two stations that are communicating, having received at least one of the RTS or CTS frames set up, on the basis of the information received, their “NAV” (“Network Allocation Vector”) indicator, that is to say a period during which they stop all activity so as not to disturb the transfer of data.
After receipt of the CTS frame, the first station dispatches the data to be transferred to the second station in one or more DATA frames.
The second station receives the data and dispatches an ACK frame to the first station to signal the correct receipt of the data.

In the European Patent Application published under the number 1 335 545, a receiving station operating in antenna diversity mode uses test frames generated by a transmitting station before undertaking transmission of the DATA frames. These test frames serve for the identification of a reception antenna from among the plurality of reception antennas which sets up the best communication link with the transmitting station. The identification mechanism is based on a measurement of the power of the signal in terms of reception of the test frames (so-called “RSS” measurement—“Received Signal Strength”). The identification mechanism may be more efficacious by making a measurement on the preamble which also constitutes a known sequence. With this method, the transmission of the test frames occupies bandwidth, thereby reducing the performance of the network.

### 3. INVENTION SUMMARY

An aim of the invention is to propose a method for operating a transmitting/receiving station of a wireless communication network in antenna diversity mode with which it is not necessary to use specific test frames.

For this purpose, the invention is a method of operating a transmitting/receiving station of a wireless communication network in antenna diversity mode, this station having a plurality of reception antennas. The method consists in:
listening to the communications between two other transmitting/receiving stations of the network, successively on each reception antenna,
analysing the quality of listening on each reception antenna so as to identify a reception antenna from among the plurality of reception antennas which sets up the best communication link with one of the said other two transmitting/receiving stations.

According to a particular embodiment of the invention, one of the two other transmitting/receiving stations of the network is an access point of the network.

According to another embodiment of the invention the analysis of the quality of listening is validated on reception of an acknowledgement frame.

With this method, the choice of the reception antenna for operating in antenna diversity mode is made in the station during its period of inactivity (that is to say the period of reserved medium defined by the NAV indicator). With the method according to the invention, the stations no longer use test frames to operate in antenna diversity mode. The method according to the invention consequently helps to improve the performance of a wireless communication network, without degrading the bandwidth.

The method according to the invention can exhibit the following features:

the analysis of the quality of listening is based on a measurement of the power of the signal in terms of reception of frames originating from the said other stations;
the analysis of the quality of listening is based on a comparison of the data of a frame originating from the said other stations with predetermined data.

According to one embodiment of the invention, the analysis of the quality of listening is based on a combination of a measurement of the power of the signal in terms of reception of frames originating from the other stations and of a comparison of preamble with predetermined data for a first tested antenna and on a measurement of the power of the signal in terms of reception of frames (DATA) originating from the said other stations for other antennas to be tested.

According to a particular embodiment, the first tested antenna is the antenna whose said associated combination of measurements is the oldest one.

According to another particular embodiment, the comparison of preamble with predetermined data is a correlation measurement.

The invention extends to a transmitting/receiving station specially devised to implement the method of the invention indicated hereinabove, as well as to a wireless communication network comprising such transmitting/receiving stations.

### 4. LIST OF FIGURES

The invention is now described in greater detail and illustrated by the drawings.

FIG. 1 shows very diagrammatically a wireless communication network with transmitting/receiving stations according to the invention.

FIG. 2 is a very diagrammatic schematic illustrating a first implementation of the method according to the invention for operating a station in antenna diversity mode.

FIG. 3 is a very diagrammatic schematic illustrating a second implementation of the method according to the invention for operating a station in antenna diversity mode.

FIG. 4 is a very diagrammatic schematic illustrating a third implementation of the method according to the invention for operating a station in antenna diversity mode.

### 5. DETAILED DESCRIPTION OF THE INVENTION

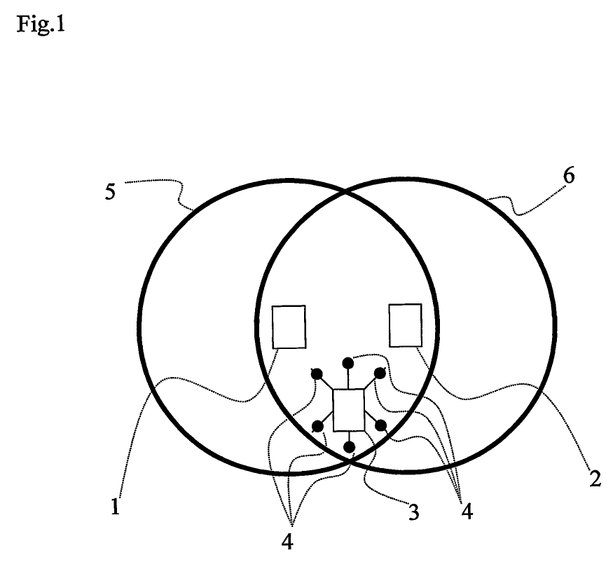

Illustrated in FIG. 1 is the topology of a wireless communication network according to the invention with a transmitting/receiving station 3 having a plurality of reception antennas 4. Two other stations 1 and 2 capable of communicating with one another have been represented in this wireless communication network. Of course, a wireless communication network according to the invention can comprise a greater number of stations. The stations 1 to 3 may be fixed or mobile such as computers, access points of the network or audio and video appliances. The access point of the network is defined as the communication manager of the network.

The circle 5 in FIG. 1 diagrammatically represents the transmission radiation of the transmitting antenna of the station 1 when it dispatches RTS and DATA frames. In the same way, the transmission radiation of the transmitting antenna of the station 2, when it dispatches CTS and ACK frames, is represented by the circle 6.

As visible in FIG. 1, the station 3 is placed inside the zone of radiation of the stations 1 and 2, so that during communication between the stations 1 and 2, the station 3 can receive the RTS, CTS, DATA and ACK frames.

According to the invention, the frames exchanged between the stations 1 and 2 are used by the station 3 to identify that one among its reception antennas 4 which sets up the best communication link with the station 1 for example.

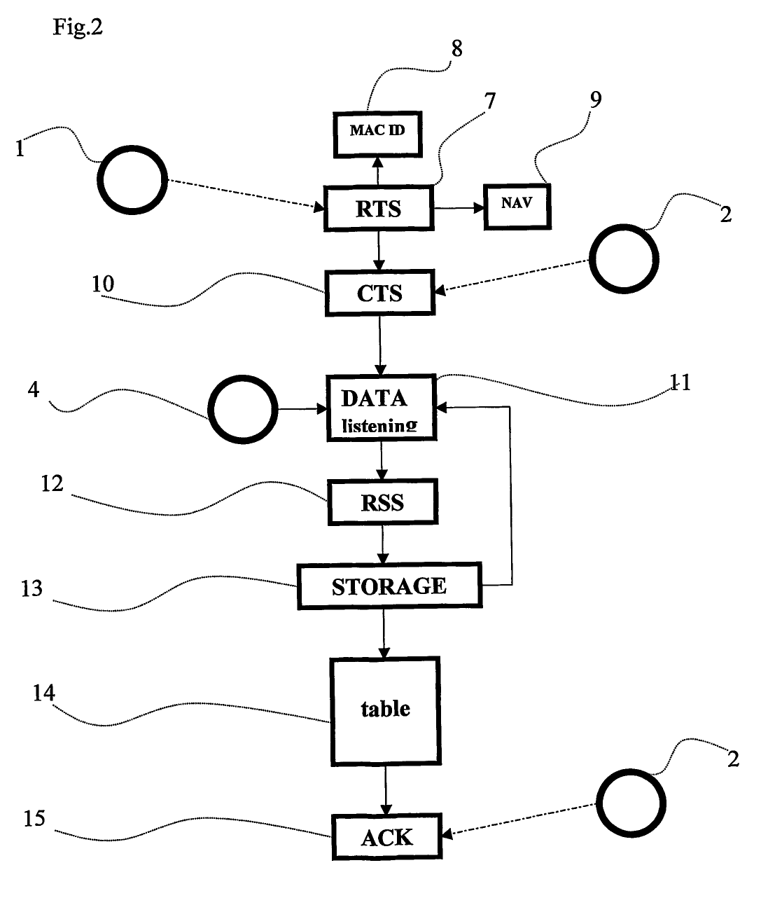

FIG. 2 is a schematic illustrating a first exemplary implementation of the method according to the invention for operating station 3 in reception antenna diversity mode.

At 7, the station 3 picks up an RTS frame transmitted by the station 1, this RTS frame serving the station 1 to reserve the communication medium with a view to a communication with the station 2.

At 8, the station 3 extracts the MAC ID address of the station 1 from the RTS frame and stores this MAC ID address in a table. In addition, the station 3 extracts the NAV indicator from the RTS frame (block 9 in FIG. 2).

As indicated above the NAV indicator is an item of information indicative of the time for which the stations 1 and 2 will exchange the CTS, DATA and ACK frames.

At 10, the station 3 now picks up the CTS frame transmitted by the station 2. The station 3 can also extract the MAC ID of the station 1 from this CTS frame for storage thereof in the table as well as the duration of the NAV indicator. Moreover, the station 3 extracts an “RA” (“Receiver Address”) from the CTS frame likewise indicative of the MAC ID of the station 1.

At 11, the station 3 is now in the phase of listening to the DATA frames exchanged between the stations 1 and 2 and picks up on a first reception antenna 4 the first DATA frame transmitted by the station 1.

At 12, the station 3 performs an analysis of the quality of listening on the antenna 4 by measuring the power of the signal in terms of reception of the DATA frame and at 13 the station 3 records the results of this measurement in the table in correspondence with the identifier of the current reception antenna 4. The station 3 continues its processing by returning to step 11 for another current reception antenna 4 and identifying the station 1. The station 3 therefore chains together the loop of processing operations 11, 12, 13 in succession over the whole set of its reception antennas 4 so as to obtain a table in which there is a correspondence of the reception antennas 4 and the various measurement values corresponding to the station 1. This measurement of the power of the signal can be a known measurement of the RSS type.

It will be understood that the duration of the sending of one or more DATA frames, divided by the time for a RSS measurement on a reception antenna 4, gives the number of reception antennas 4 that will be able to be scanned in one or more processing loops 11, 12, 13 during a transaction between the stations 1 and 2.

At 14, on completion of the transaction between the stations 1 and 2, the station 3 identifies on the basis of the table indicated above the reception antenna 4 which sets up the best communication link with the station 1 in reception. The best communication link corresponds to the measurement of the largest power of the signal.

By picking up at 15 the ACK frame transmitted by the station 2, the station 3 validates the identification of the reception antenna 4 carried out in step 14. This antenna 4 will subsequently be used by the station 3 to communicate with the station 1.

The station 3 is devised to repeat the processing illustrated in FIG. 2 for each other station of the network which transmits DATA frames so as to continuously update its tables containing the results of the RSS measurements.

The station 3 may be devised to carry out the updating of the RSS measurements table associated with a station of the network, for example the station 1, over several transactions of the station 1.

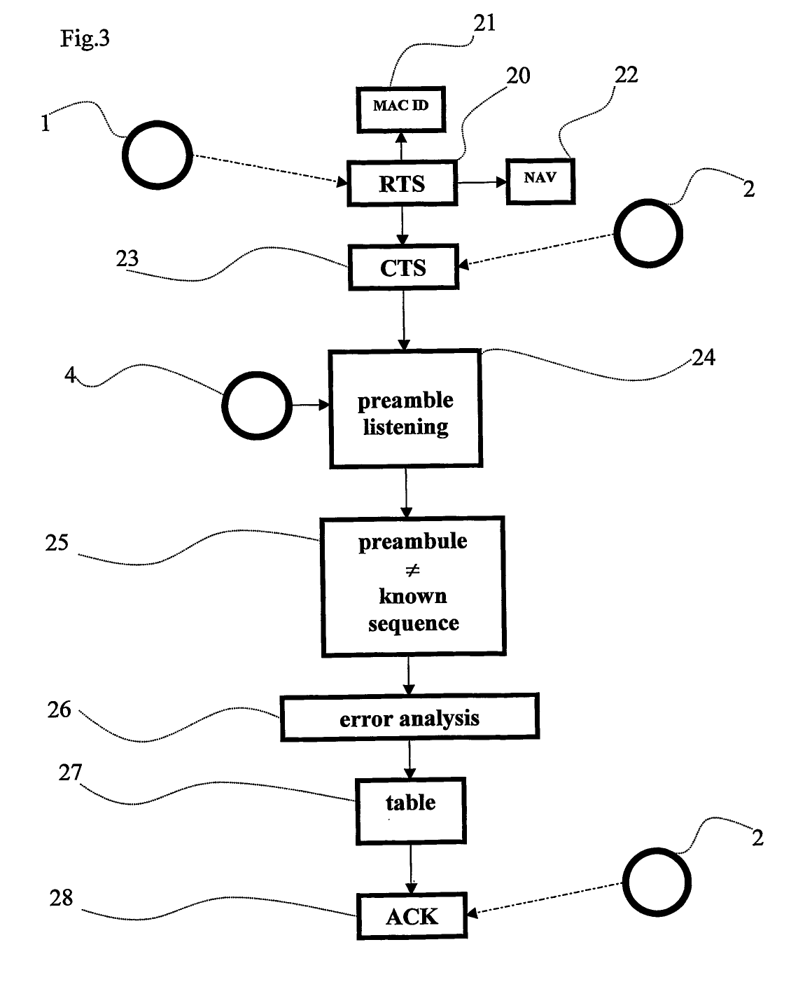

FIG. 3 is a schematic illustrating a second exemplary implementation of the method according to the invention for operating the station 3 in reception antenna diversity mode.

At 20, the station 3 picks up an RTS frame transmitted by the station 1 so as to reserve the medium with a view to a communication with the station 2. At 21, the station 3 extracts the MAC ID address of the station 1 from the RTS frame, which address is stored in a table, as is the NAV indicator (block 22).

At 23, the station 3 picks up the CTS frame transmitted by the station 2.

At 24, the station 3 is now in the phase of listening to the frames exchanged between the stations 1 and 2 and picks up on a first reception antenna 4 a DATA frame transmitted by the station 1. This DATA frame comprises a preamble which contains synchronization data in particular.

At 25, the station 3 performs an analysis of the quality of listening on the reception antenna 4 by comparing the synchronization data bitwise with prerecorded data. These prerecorded data are for example the twenty-four bits, alternating zeros and ones, of a synchronization sequence.

At 26, the station 3 performs an error analysis following this comparison so as to evaluate the quality of reception on the antenna 4 considered. The result of this error analysis is recorded in a table in correspondence with the identifier of the current reception antenna 4 (block 27).

By picking up at 28 the ACK frame transmitted by the station 2, the station 3 validates the error analysis performed in step 27.

It will be understood that the correspondence table for the reception antennas 4 will be completed through an analysis of several DATA frames originating from the station 1. The antenna which sets up the best communication link with the station 1 is that which exhibits the lowest error level in the comparison of the preamble. Moreover, the station 3 may be devised to repeat the processing illustrated in FIG. 3 for each other station of the network which transmits DATA frames and to continuously update the tables containing the error analysis results.

The antenna identification selection method for operation in antenna diversity mode, illustrated in FIG. 3, exhibits good reliability and can supplement the method illustrated in FIG. 2.

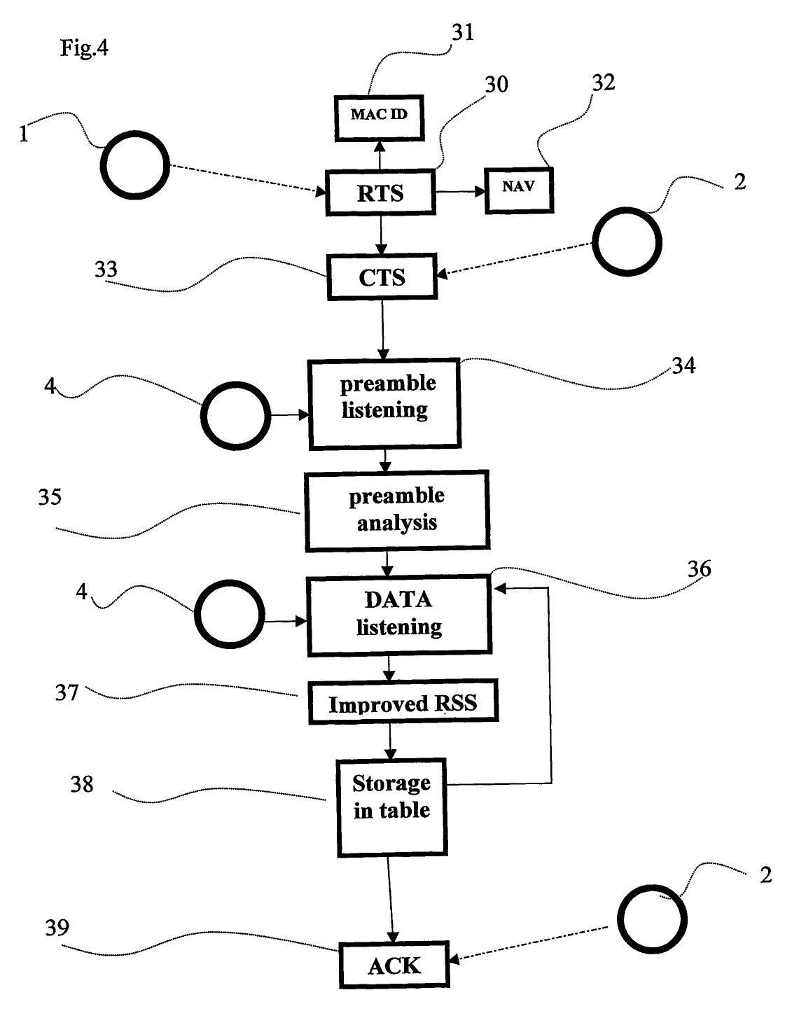

FIG. 4 is a schematic illustrating a third exemplary implementation of the method according to the invention for operating the station 3 in reception antenna diversity mode. On FIG. 4, we only represent the case where station 3 picks up frames exchanged between two other stations 1 and 2. For the sake of clarity, we did not represent normal case where station 3 is exchanging frames with another station.

At 30, the station 3 picks up an RTS frame transmitted by the station 1 so as to reserve the medium with a view to a communication with the station 2. At 31, the station 3 extracts the MAC ID address of the station 1 from the RTS frame, which address is stored in a table, as is the NAV indicator (block 32).

At 33, the station 3 picks up the CTS frame transmitted by the station 2.

At 34, the station 3 is now in the phase of listening to the frames exchanged between the stations 1 and 2 and picks up on a first reception antenna 4 a DATA frame transmitted by the station 1. This DATA frame comprises a preamble which contains synchronization data in particular.

At 35, the station 3 performs an analysis of the quality of listening on a first reception antenna 4 by comparing the synchronization data with prerecorded data. By comparing the preamble of DATA frame with predetermined data, we get a confidence indicator that characterizes the reception performance of currently tested antenna 4. This comparison can be a correlation measure. According to the invention any quality measure based on the preamble can be used thus as the one defined in FR 0115892. In the framework of HiperLan/2, the BBC part of frames exchanged during a DiL phase is a preamble long enough to do such measurements.

At 36, after preamble analysis, the station 3 performs an analysis of the quality of listening on the first reception antenna 4 by measuring the power of the signal in terms of reception of the DATA frame. This measure of the power of the signal can be a known measure of the RSS type.

This power level measure is thus combined with the preamble measure performed at 35 to obtain an improved RSS measure at 37. The combination can be a weighted sum of both measures. This improved RSS measure is then stored in a table at 38.

The station 3 continues its processing by returning to step 36 for a second reception antenna 4 and by identifying the station 1. For this other reception antenna 4, a simple measure of power of the signal in terms of reception of the DATA frame 61 is used. The station 3 therefore chains together the loop of processing operations 36, 37, 38 in succession over the whole set of remaining reception antennas 4 so as to obtain a table in which there is a correspondence of the reception antennas 4 and the various measurement values corresponding to the station 1.

By picking up at 39 the ACK frame transmitted by the station 2, the station 3 validates the previous measurements.

It will be understood that the correspondence table for the reception antennas 4 will be completed through an analysis of several DATA frames originating from the station 1. The antenna which sets up the best communication link with the station 1 is that which exhibits the largest combined measure.

Moreover, the station 3 may be devised to repeat the processing illustrated in FIG. 4 for each other station of the network which transmits DATA frames and to continuously update the tables containing the analysis results.

According to a particular embodiment of the invention, the first tested antenna for which we estimate an improved RSS measure is one of the antenna 4 that has no improved RSS measure associated with it. If all antenna 4 have an improved RSS measure associated with them, then the first tested antenna 4 is the antenna whose improved RSS measure is the oldest one.

With the method according to the invention, the identification of an antenna for operation in reception antenna diversity mode is performed during the period of inactivity of each station of the wireless communication network, thus not affecting the performance of this network.

The choice of the best reception antenna in a station operating in antenna diversity mode helps to increase the reception gain of the station and to reduce the interference, thereby limiting the errors on reception. Moreover, the reliability of the network is improved, thereby making it possible to decrease the error margins used to compensate for the attenuation of the power of the signal and to reach longer ranges or a bigger throughput.

The method according to the invention is more particularly advantageous in networks where the exchanges of DATA frames are numerous between stations. Therefore the measurement are refreshed very fast without any bandwidth degradation. In particular, the method according to the invention is very suitable for a busy network.

Of course, the invention may be applied to other communication standards provided that the communication network permits direct links between stations of the network.

In the case of the Hiperlan/2 standard, a CC station operates in reception antenna diversity mode and identifies for each MT station, with the method according to the invention, during a direct link connection between two other MT stations, a reception antenna for communicating with the MT station considered. Moreover, each MT station identifies a reception antenna from among its various reception antennas for setting up the best communication link with the CC station during a downlink connection. Furthermore, each MT station identifies a reception antenna from among its various reception antennas for setting up the best communication link with an MT station during an uplink connection.

For centralized network (i.e. IEEE802.11 in BSS), the invention may also be applied for the stations. All stations operate in reception antenna diversity mode during a communication between the AP and another station, thus identify a reception antenna from among its various reception antennas for setting up the best communication link with the AP station.

1. A method of operating a transmitting/receiving station of a wireless communication network in antenna diversity mode, this station having a plurality of reception antennas wherein it consists in:
listening to the communications between two other transmitting/receiving stations of the network, successively on each reception antenna,
analysing the quality of listening on each reception antenna so as to identify a reception antenna from among the plurality of reception antennas which sets up the best communication link with one of the said other two transmitting/receiving stations.

2. The method according to claim 1, wherein one of the two other transmitting/receiving stations of the network is an access point of the network

3. The method according to claim 1, wherein the analysis of the quality of listening is validated on reception of an acknowledgement frame.

4. The method according to claim 1, wherein the analysis of the quality of listening is based on a measurement of the power of the signal in terms of reception of frames originating from the said other stations.

5. The method according to claim 1, wherein the analysis of the quality of listening is based on a comparison of the data of a frame (DATA) originating from the said other stations with predetermined data.

6. The method according to claim 4, wherein the analysis of the quality of listening is based on a combination of a measurement of the power of the signal in terms of reception of frames originating from the said other stations and of a comparison of preamble with predetermined data for a first tested antenna and on a measurement of the power in terms of reception of frames originating from the said other second antennas to be tested.

7. The method according to claim 6, wherein the first tested antenna is the antenna whose said associated combination of measurements is the oldest one.

8. The method according to claim 6, wherein said comparison is a correlation measurement.

9. A transmitting/receiving station having a plurality of reception antennas for operating in antenna diversity mode in a wireless ion network, wherein it comprises:
means for listening to the communications between two other transmitting/receiving stations of the network, successively on each reception antenna,
means for analysing the quality of listening on each reception antenna so as to identify a reception antenna from among the plurality of reception antennas which sets up the best communication link with one of the said other two transmitting/receiving stations.

10. The station according to claim 9, wherein one of the two other transmitting/receiving stations of the network point of the network.

11. The station according to claim 9, wherein the analysis of the quality of listening is validated on reception of an acknowledgement frame.

12. The station according to claim 9, wherein the analysis of the quality of listening is based on a measurement of the power of the signal in terms of reception of frames originating from the said other stations.

13. The station according to claim 9, wherein the analysis of the quality of listening is based on a comparison of the data of a frame originating from the said other stations with predetermined data.

14. The station according to claim 12, wherein the analysis of the quality of listening is based on a combination of a measurement of the power of the signal in terms of reception of frames originating from the said other stations and of a comparison of preamble with predetermined data for a first tested antenna and on a measurement of the power of the signal in terms of reception of frames originating from the said other stations for second antennas to be tested.

15. The station according to claim 14, wherein the first tested antenna is the antenna whose said associated combination of measurements is the oldest one.

16. The station according to claim 14, wherein said comparison is a correlation measurement.

17. A wireless communication network comprises one or more stations according to claim 9.
